(19) United States
(12) Patent Application Publication
(10) Pub. No.: US 2014/0099252 A1
(43) Pub. Date: Apr. 10, 2014

(54) System and method for supplying hydrogen and deuterium to lenr and e-cat based energy generating systems

(71) Applicants: Marc Kenneth Chason, Schaumburg, IL (US); Daniel Roman Gamota, Palatine, IL (US); Rick Latella, Woodstock, IL (US)

(72) Inventors: Marc Kenneth Chason, Schaumburg, IL (US); Daniel Roman Gamota, Palatine, IL (US); Rick Latella, Woodstock, IL (US)

(21) Appl. No.: 13/573,857

(22) Filed: Oct. 9, 2012

(51) Int. Cl. C01B 4/00; C01B 3/32; C01B 3/26

(52) U.S. Cl. CPC C01B 4/00; C01B 3/26; C01B 3/32
USPC 423/647.7; 423/648.1; 423/650; 422/129; 422/187; 204/278; 205/637

(57) ABSTRACT

An approach for supplying hydrogen and/or deuterium to LENR and E-Cat based energy generating systems includes receiving a source material that is rich in hydrogen and/or deuterium. A gaseous form of at least one of those elements is extracted from the source material via electrochemical dissociation, hydrocarbon recovery, or a suitable mechanical process. The gaseous form of the element is preferably filtered to remove water vapor and other impurities before being pressurized and supplied to the energy generating system. Advantages of the approach include enhanced safety and system portability due to elimination of a need for pressurized gas storage tanks.

### STATEMENT OF RELATED APPLICATIONS

The present application is related to, and claims priority to, U.S. Provisional Patent Application No. 61/545,485 (filed on Oct. 10, 2011, by the same inventors as the present invention), the entire disclosure of which is incorporated herein by reference.

### FIELD OF THE INVENTION

The present invention relates to the general field of energy conversion systems. More particularly, the present invention relates to providing hydrogen and deuterium as fuel for low-energy nuclear reaction (LENR) and Energy Catalyzer (E-Cat) based energy systems.

### BACKGROUND OF THE INVENTION

Energy generating systems that utilize either hydrogen (H2) gas or deuterium (D2) gas as a fuel source are known in the prior art. Significant limitations of prior art systems include reliance upon conventional gas cylinders and/or gas piping distribution systems, which have substantial associated costs and very limited mobility/portability. Examples of two prior art systems, and comments as to their apparent limitations, are briefly discussed as follows.

U.S. Pat. No. 7,893,414 (issued to Larsen et al.) describes a method for generating useable heat from a Low Energy Nuclear Reaction (LENR) based reaction. Larsen discloses a system that includes a source of hydrogen or deuterium associated with a “cavity,” but does not offer any teachings as to how the hydrogen or deuterium is produced or supplied; presumably, the gases would be supplied from a conventional pressurized cylinder, which would negatively impact the portability of the system.

U.S. Patent Publication 2011/0005506 (filed by Rossi) describes an Energy Catalyzer (E-Cat) device for generating heat via an exothermal process based on proton absorption by a host nucleus. Viewed in light of the aforementioned Larsen patent, it is suspected that Rossi's E-Cat process is actually a type of LENR process. In Rossi's process, which has been demonstrated in at least a few public venues, hydrogen gas is supplied via pressurized cylinder. As in Larsen's patent, Rossi's publication mentions that a source of hydrogen or deuterium is associated with a cavity, but offers no further significant teachings in that regard. In both Larsen and Rossi, the absence of any meaningful teachings as to the gas supply system highlights the lack of existing art that might enable a low cost and readily portable gas supply system for those types of energy producing systems.

As has already been touched upon, the use of hydrogen or deuterium gas supplied from pressurized cylinders has several disadvantages. First, it greatly reduces portability of the associated energy systems. Second, that approach requires replenishment of the gas with new gas storage cylinders. Additionally, pressurized cylinders pose a significant safety hazard due to the high pressure storage and flammability of stored H2 and D2 gas if it should escape from the cylinder.

An existing alternative to the use of pressurized cylinders is to employ distribution systems similar to those which are used for the delivery of natural gas. Unfortunately, this approach likely reduces energy system portability, and requires significant investment in a gas piping distribution system.

It is therefore apparent that a hydrogen or deuterium supply source fuel module that can be readily integrated with a suitable energy generating device (such as a LENR or E-Cat device), and that supplies hydrogen or deuterium gas in a safe and portable manner, would represent a substantial improvement in the art.

### BRIEF DESCRIPTION OF THE DRAWINGS

FIG. 1 describes an electrochemical process and apparatus for dissociating hydrogen and deuterium from liquid water, in accordance with the prior art.

FIG. 2 describes a typical system for dissociating hydrogen and/or deuterium from an organic based liquid such as methanol, in accordance with the prior art.

FIG. 3 describes a system for providing hydrogen and/or deuterium to a LENR or E-Cat based energy generating system, in accordance with the preferred embodiments of the present invention.

FIG. 4 describes the system depicted in FIG. 3, with the addition of powered products, in accordance with the preferred embodiments of the present invention.

### DETAILED DESCRIPTION OF THE PREFERRED EMBODIMENTS

The present system and method are directed to providing a supply source fuel module that is integrated with a LENR or E-Cat based energy generating device/system for safe, on-time, on-site supply of hydrogen and/or deuterium as needed for use by the LENR or E-Cat reactor.

A key component for implementing the invention is an electrochemical dissociation chamber that is preferably filled with water plus an electrolyte, or to a reformer system for a hydrocarbon based material (e.g., methane, alcohol, gasoline, oil, wax, etc.) that is rich in hydrogen and/or deuterium. It should be understood that the terms “hydrogen” and “deuterium,” as those terms are used herein, refer to the respective elements (and not just to the gaseous forms of those elements).

In a first group of preferred embodiments, the invention works by dissociating the hydrogen and/or deuterium rich source liquid into its constituent gases. For example, the invention operates by any of the following three approaches: (i) dissociating a source of liquid water into hydrogen and oxygen; (ii) dissociating heavy water into deuterium and oxygen; or (iii) dissociating a combination of water and heavy water to produce a gas that contains both hydrogen and deuterium.

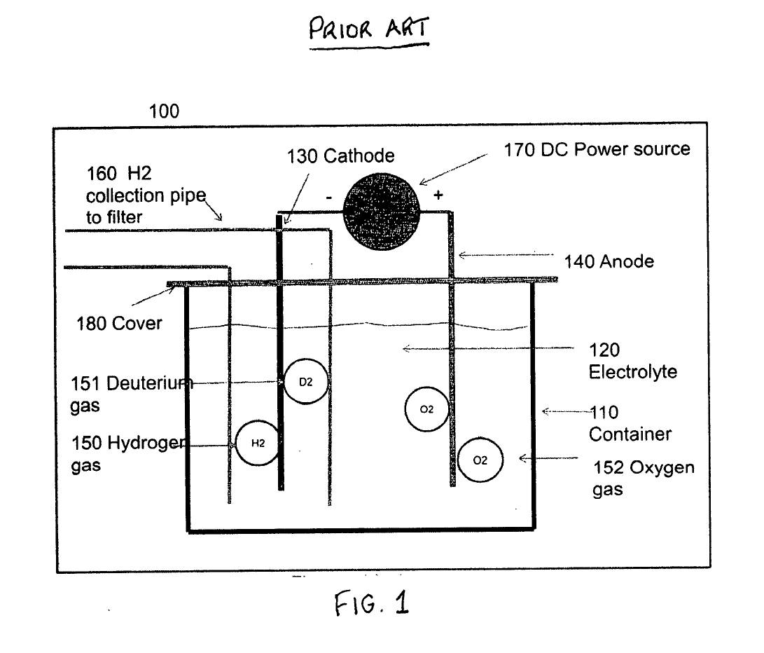

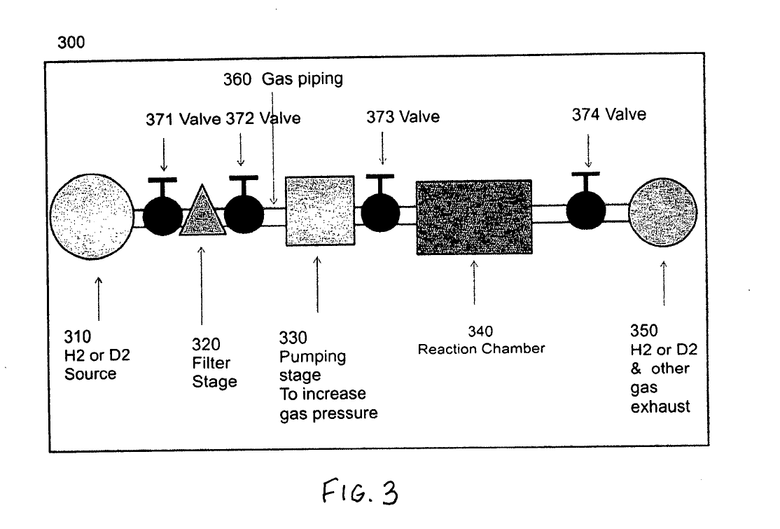

FIG. 1 describes an electrochemical dissociation process 100. A covered vessel 110,180 contains water and an electrolyte 120 (composed of salts, acids, or bases). The electrolyte 120 is energized via two electrodes (cathode 130 and anode 140) supplied by DC power source 170, thereby dissociating the water into hydrogen gas 150, deuterium gas 151, and oxygen gas 152. The hydrogen 150 and deuterium 151 are collected in a pipe 160. As will be described in further detail herein, pipe 160 leads to a filter stage (320 in FIG. 3) which removes water vapor and other contaminants before the hydrogen and/or deuterium is fed into a reaction chamber of the LENR or E-Cat energy generating system. Cover 180 includes appropriate feedthroughs for piping and electrical leads.

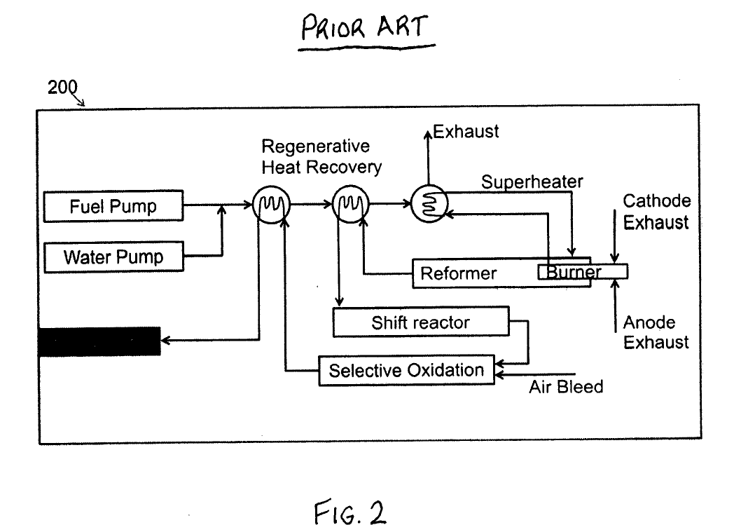

In an alternative embodiment, the source material is a hydrocarbon based material from which hydrogen and/or deuterium can be separated by “cracking” the hydrocarbons to release the hydrogen and/or deuterium. The remaining lower molecular weight hydrocarbons can continue to be “cracked” until a “waste” carbon and/or even lower molecular weight compounds remain and can be disposed of. This process is similar to that which is used to produce hydrogen re-former sources in methanol based fuel cells. FIG. 2 describes a typical system, sometimes referred to as a hydrogen reformer, which is known to those skilled in the art.

In other alternative embodiments, the source need not be a liquid. Solid or solid-like materials that store hydrogen and release it when dissociated by heat or appropriate mechanical methods may also be employed. Examples include, but are not limited to, hydrogen or deuterium gas storage in structures such as microbeads, microspheres, metallic sponges, etc. As but one example, the microbeads (which can be purchased from commercial suppliers, such as 3M) may be filled with hydrogen. Later, when needed, the microbeads can be fractured to release the hydrogen; the waste materials from the spent microbeads, such as glass or polymers, can be removed.

The electrical energy that is required for dissociating water or reforming a hydrocarbon based material (e.g., methanol) can be supplied from any of a number of sources, such as from power line or grid-based systems, thermoelectric processes (including those which utilize a portion of the thermal energy produced by reactor 340), an electrical generator powered by a portion of the energy produced by reactor 340, energy stored in an electrochemical cell, electrical energy from a photovoltaic system, electrical energy from a wind turbine system, etc

Referring now to FIG. 3, the hydrogen and/or deuterium gas stream(s) 310 produced by the dissociation process (or, alternatively, by mechanical separation) preferably pass through a first valve 371, a filter stage 320, a second valve 372, a pumping stage 330, and a third valve 373 before being supplied to a reaction chamber 340 within the LENR or E-Cat system. Filter stage 320 includes elements for removing water vapor and/or any volatile organic compounds prior to the gas stream(s) being appropriately pressurized (by way of physical methods or by use of metal hydrides) by pumping stage 330 and then supplied to reaction chamber 340. Examples of suitable types of filters include, but are not limited to, filter membranes, zeolite molecular sieves, electrostatic filters, metal hydrides, etc. Fourth valve 374 controls the venting of exhaust products 350 from reaction chamber 340. It will be appreciated that gas piping 360, which is depicted in FIG. 3 as straight-line sections, may include angles/bends as necessary to accommodate construction requirements, etc.

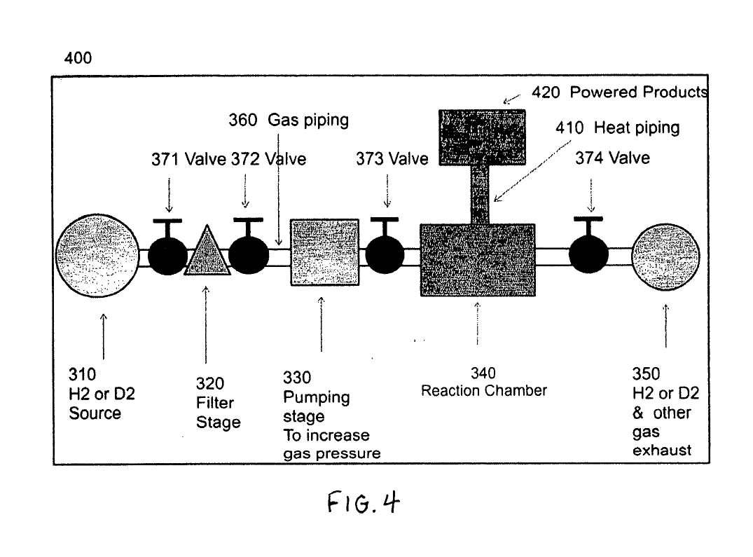

FIG. 4 illustrates that the thermal energy produced by reaction chamber 340 is transferred, via heat piping 410, for use by one or more powered products 420. The powered products may use the thermal energy as delivered or may convert it to electrical or steam energy as required to appropriately operate the powered products.

The present invention thus provides an attractive alternative to those existing approaches which require flammable, pressurized hydrogen and/or deuterium gases to operate LENR and E-Cat based energy generating systems. Because of its safety advantages and portability, the disclosed invention is capable of enabling a broad range of LENR and E-Cat powered products in locations such as, but not limited to, on-grid electrical communities and off-grid electrical communities in developed and undeveloped regions, as well as in remote locations for camping, military operations, and exploration (e.g., terrestrial, marine, space). Powered product applications include, but are not limited to, space heating, water heating, process heating, primary and secondary sources of electricity generation, powered transportation (e.g., automotive, motorcycle, bicycle, rail, marine, air, space), telecommunications, lighting, emergency and catastrophe support operations, and water purification/distillation.

Although the present invention has been described with reference to certain preferred embodiments, numerous modifications and variations can be made by those skilled in the art without departing from the novel spirit and scope of this invention.

What is claimed is:

1. An arrangement for supplying a gas stream to an energy generating system, comprising:
a source material that is rich in at least one element that constitutes a suitable fuel source for the energy generating system;
a dissociating apparatus that is operable to receive the source material and to dissociate the at least one element from other constituents of the source material, thereby producing a gaseous form of the at least one element; and
a pressurizing means for pressurizing the gaseous form of the at least one element before providing the gaseous form of the at least one element to the energy generating system.

2. The arrangement of claim 1, wherein the energy generating system is one of:
(a) a low energy nuclear reaction (LENR) based system; and
(b) an energy catalyzer (E-Cat) based system.

3. The arrangement of claim 2, wherein the at least one element is at least one of: (a) hydrogen; and (b) deuterium.

4. The arrangement of claim 3, wherein the source material consists essentially of at least one of: (a) water; and (b) heavy water.

5. The arrangement of claim 3, wherein the source material consists essentially of a hydrocarbon based material.

6. The arrangement of claim 5, wherein the dissociating apparatus includes a hydrocarbon reformer.

7. The arrangement of claim 4, wherein the dissociating apparatus is operable to provide electrochemical dissociation.

8. The arrangement of claim 3, wherein the source material consists essentially of at least one gas that is encapsulated in a solid material.

9. The arrangement of claim 8, wherein the dissociating apparatus is replaced by a mechanical apparatus that liberates the at least one gas by fracturing the solid material encapsulating the at least one gas.

10. The arrangement of claim 3, further comprising a filter stage for removing impurities from the at least one gas before pressurizing and providing the at least one gas to the energy generating system.

11. The arrangement of claim 10, wherein the filter stage comprises at least one of: (a) paper filters; (b) zeolite molecular sieves; (c) electrostatic filters; and (d) metal hydrides.

12. A method for supplying a gas stream to an energy generating system, comprising the steps of:
(A) providing a dissociating apparatus for:
(i) receiving a source material that is rich in at least one material selected from the group consisting of: (a) hydrogen; and (b) deuterium; and
(ii) dissociating the at least one material from other constituents of the source material, thereby producing a gaseous form of the at least one material;
(B) pressurizing the gaseous form of the at least one material; and
(C) supplying the gaseous form of the at lease one material to the energy generating system.

13. The method of claim 12, further comprising the step of filtering impurities from the at least one gas before pressurizing and supplying the at least one gas to the energy generating system.

14. The method of claim 12, wherein the energy generating system comprises one of:
(a) a low energy nuclear reaction (LENR) system; and
(b) an energy catalyzer (E-Cat) system.

15. The method of claim 12, wherein the source material consists essentially of at least one of: (a) water; and (b) heavy water.

16. The method of claim 12, wherein the source material consists essentially of a hydrocarbon based material.

17. The method of claim 16, wherein the step of dissociating includes performing a hydrocarbon reformer process.

18. The method of claim 15, wherein the step of dissociating includes electrochemical dissociation.

19. The method of claim 12, wherein the source material consists essentially of at least one gas that is encapsulated in a solid material.

20. The method of claim 19, wherein the step of dissociating is replaced by fracturing the solid material encapsulating the at least one gas.
